(19) United States
(12) Patent Application Publication
(10) Pub. No.: US 2018/0164263 A1
(43) Pub. Date: Jun. 14, 2018

(54) OPTOCHEMICAL SENSOR

(71) Applicant: Mettler-Toledo GmbH, Greifensee (CH)

(72) Inventors: Milan Fischer, Liebefeld (CH); Lilya Ulmer, Mettmenstetten (CH); Francesca Venturini, Dübendorf (CH)

(21) Appl. No.: 15/834,359

(22) Filed: Dec. 7, 2017

(30) Foreign Application Priority Data
Dec. 9, 2016 (EP) 16203104.1

(51) Int. Cl. G01N 31/22; G01N 21/64; G01K 11/12

(52) U.S. Cl. CPC G01N 31/223; G01N 31/225; G01K 11/12; G01N 21/643

(57) ABSTRACT

A sensor (202) uses an optical-sensing technique for determining more than one parameter in a measurement medium (204). The sensor has an optochemical sensitive element (208) with a first sensing layer (228) and a second sensing layer (230). Each of the sensing layers is arranged on a substrate (222). The first sensing layer has a first indicator (236) that determines a first parameter and the second sensing layer has a second indicator (238) that determines a second parameter in the measurement medium.

### CROSS-REFERENCE TO RELATED APPLICATIONS

This application claims priority to EP 16 203 104.1, filed 9 Dec. 2016, the content of which is incorporated by reference as if fully recited herein.

### TECHNICAL FIELD

The disclosed embodiments relate to an improved optochemical sensor for the determination of at least two parameters in a measurement medium.

### BACKGROUND OF THE ART

Optochemical sensors find application for the determination of a wide variety of analytes such as dissolved gases, metal ions etc. in environmental, industrial, laboratory, medical and biological applications.

In principle, the operation of an optochemical sensor relies on an optical-sensing technique, such as photoluminescence. The phenomenon of photoluminescence involves absorption of photons followed by subsequent emission of light. An optochemical sensor based on this operating principle comprises a signaling substance, commonly referred to as an indicator that is capable of interacting with the analyte to be measured in the process medium. The indicator can either be in direct or indirect contact with the process medium.

In optochemical sensors based on photoluminescence, a reduction of photoluminescence caused by the analyte is detected, known as photoluminescence quenching. Under this principle, the molecules of an indicator are excited by irradiation with light of a suitable wavelength. As the molecules relax from the excited state back to the ground state, they release the absorbed energy again in the form of photoluminescence. Physical interaction between the analyte and the indicator causes enhanced relaxation via a non-radiative channel, which leads to decrease of the photoluminescence intensity and increase of the relaxation rate-quenching. Depending on the indicators direct emission is not possible and the system relaxes through an additional state with greatly reduced transition rate.

The principle of photoluminescence covers in particular two phenomena, namely fluorescence and phosphorescence, which differ in their photophysical process that occurs in the molecule during excitation and emission. Indicators that are used in an optochemical sensor based on either the fluorescence or the phosphorescence phenomenon are better known as fluorophors or phosphorescent indicators respectively.

In principle, it is possible to determine many analytes such as H⁺, dissolved gases, such as carbon dioxide, oxygen also ozone, etc., in a process medium by photoluminescence and photoluminescence quenching, as long as the signal substance, for example an indicator, is sensitive in regard to the parameter of interest in the process medium. The term “process medium” in this context encompasses liquids and gases as well as mixtures thereof.

U.S. published application 2010/0203649 A1 describes an optochemical sensor element used in an optochemical measuring device. It comprises an indicator immobilized in a polymer matrix that is applied on a substrate. The optochemical sensor element is used for the measurement of gaseous or dissolved analytes, such as oxygen, sulfur dioxide, hydrogen peroxide or nitric oxide. The optochemical sensor is said to have high stability, good optical transparency and good resistance to mechanical stress and ensures fast measurement of gaseous or dissolved parameter in precise manner.

As previously known, most optical indicators are cross-sensitive to temperature, since both photoluminescence and quenching phenomena are temperature dependent. In applications concerning use of such optochemical sensors to determine a certain parameter, the concentration determination of the analyte is often corrected for temperature. What can be intriguing about temperature compensations is a false temperature measurement because this would translate directly in measurement errors which could affect the measurement medium and therefore a process under observation. This is of special concern in gas applications where the temperature of the process medium can change by more than several tenths of degrees within several seconds thereby calling for a quick temperature measurement.

Baleizao et al. (Anal. Chem. 80, 6449-6457, 2008) describe a dual fluorescence sensor that takes into account the effect of temperature on the oxygen sensor. Two sensor layers containing two luminescent compounds for oxygen and temperature respectively were prepared over a polyester support. Both sensor layers were arranged on the same side of the polyester support.

In U.S. Pat. No. 6,303,386 an optochemical sensor is disclosed for the determination of temperature-compensated chemical parameters in a measurement medium. A temperature sensor is combined with a chemical sensor which contains an optical-chemical indicator which is primarily directed towards effecting temperature compensation by measuring the temperature directly in the sensitive layer of the sensor. In an embodiment described in this document, the temperature indicator and chemical indicator are immobilized in two different layers. The two layers are applied on a substrate which is then introduced into the measuring medium bringing the two sensor layers in direct contact with the medium.

This document also describes that the temperature indicator and the chemical parameter indicator may be combined into one sensor layer by immobilizing them in the same solid matrix. However, this step requires the temperature indicator to be inert towards the measuring medium. Moreover, the choice of the matrix is strongly reduced because both indicators need to be solvable in it.

In order to account for quick temperature changes in the measurement medium, a temperature sensitive indicator requires a short response time. Common reasons for long response times or slower responses of a temperature sensitive indicator towards the temperature of the measurement medium are attributed to the physical separation of the resistive thermoelement that is built into a detachable or fixed sensor tip. One attempt to overcome this is to integrate the thermoelement directly into the sensor tip. However, this in turn necessitates a good and reliable electrical connection which can become a major challenge.

Moreover in an optochemical sensor, individual sensing layers for different parameters contribute to an increased thickness owing to a stack arrangement of sensing layers thereby leading to slower response times of the optochemical sensor. Such an arrangement also necessitates that each sensing layer be mechanically and chemically compatible with each other.

Therefore, there exists a need for an improved optochemical sensor that is capable of temperature corrected parameter measurement (or dual measurement) in a measurement medium with comparable response times of the temperature and parameter measurement.

### SUMMARY

This need is met by an optochemical sensitive element for determining at least two parameters in a measurement medium comprising a substrate comprising a first surface and a second surface; at least a first sensing layer arranged on the first surface of the substrate and at least a second sensing layer arranged on the second surface of the substrate. The first sensing layer comprises a first indicator immobilized in a first polymer matrix to determine a first parameter in the measurement medium and the second sensing layer comprises a temperature sensitive indicator immobilized in a second polymer matrix to determine the temperature of the measurement medium characterized in that the first surface comprising the first sensing layer is configured to be opposite to the second surface comprising the second sensing layer. The arrangement of the first sensing layer and the second sensing layer is such that the substrate is arranged between these two sensing layers.

The above mentioned optochemical sensitive element is advantageous because the first sensing layer and the second sensing layer are physically separated from each other by means of the substrate.

The arrangement of a physical separation between the two sensing layers offers an advantage to have different indicators within the optochemical sensitive element with different response times. This further allows the preparation of two thinner sensitive layers which results in shorter response times.

The first sensing layer comprises the first indicator immobilized in the first polymer matrix. The term “indicator” refers to a phosphorescent indicator or a fluorophor, and herein, will be referred to as indicator in this invention. The first sensing layer determines the first parameter of an analyte in the measurement medium, such as a dissolved analyte, preferably dissolved oxygen. The term “analyte” denotes a substance whose property, such as concentration in the measurement medium, is being measured. The term “parameter” denotes a measured amount of the analyte in the measurement medium, such as concentration or partial pressure of the analyte in the medium and herein, will be referred to as parameter in this invention.

In exemplary embodiments, the first sensing layer is configured to determine a dissolved gas that can be any of the following: oxygen, carbon dioxide or ozone. The second sensing layer is configured to determine the temperature of the measurement medium.

The choice of the indicators for each of the sensing layers of the optochemical sensitive element depends on at least two aspects. In one aspect, the choice is dependent on the parameter that is to be measured. Suitable indicators are chosen on the basis of their long photoluminescence lifetime and those whose photoluminescence is capable of exhibiting a strong dependency on the parameter to be measured. Consequently, the choice of the indicator suited for the measurement of dissolved gases, in particular for oxygen is from any of the following: metal-organic complexes comprising a polycyclic aromatic hydrocarbon, such as pyrene and/or its derivatives, oxygen sensitive transitional metal polypyridil complex, in particular [Ru(bpy)₃]²⁺, or a metalloporphyrin complex comprising in particular platinum or palladium.

An indicator suited for the measurement of carbon dioxide as dissolved gas, is for example 8-hydroxypyrene-1,3,6-trisulfonic acid.

Examples of temperature sensitive indicator suited for the measurement of the temperature of the measurement medium include any of the following: rhodamine complex and/or its derivatives, metal ligand complex, in particular [Ru(bpy)₃]²⁺, lanthanide-doped bulk material, in particular doped Al₂O₃, or YAB doped with chromium ions. The above mentioned indicators are commercially available. Additionally, numerous suitable indicators other than the ones mentioned above are commercially available and can be used as a suitable indicator in an optochemical sensor to determine at least one parameter in a measurement medium.

Additionally, the choice of the indicator also depends on its solubility in the polymer matrix.

The following polymers are used as polymer matrices in the first and the second sensing layers in the optochemical sensitive element: polystyrene film, cyclic olefin copolymer such as ethylene-norbornene copolymer, cyclic olefin polymer (“COP”) and poly(n-methyl methacrylimide) (PMMI) as well as a combination thereof.

In an embodiment of the optochemical sensitive element, the first polymer matrix is different in composition from the second polymer matrix.

Using the polymer matrix to immobilize the indicator offers the advantage of providing high mechanical strength thereby bringing stability to the optochemical sensitive element structure. Further, the polymer matrices are also very stable in withstanding acidic and basic cleaning processes, which results in a longer service life of the optochemical sensitive element.

Also, immobilizing two or more different indicators on one polymer matrix is disadvantageous because the choice of a polymer matrix is greatly reduced. This is because all the chosen indicators need to be solvable in that selected polymer matrix. Therefore, using different polymer matrices to immobilize different indicators respectively offers an added advantage.

The thickness of the optochemical sensitive element is about 150 to 1600 μm, preferably in the range of 500 to 1200 μm. The thickness of the first sensing layer is preferably in the range of 1 to 10 μm. The thickness of the second sensing layer is preferably in the range of 10 to 100 μm. The substrate has a thickness of about 200 to 1500 mm preferably in the range of 400 to 1100 mm.

In an embodiment, the first sensing layer of the optochemical sensitive element further comprises a second indicator along with the first indicator. The first indicator is configured to determine the first parameter that being the concentration of a first analyte such as a first dissolved gas. The second indicator is configured to determine a second parameter in the measurement medium, such as the concentration of a second analyte in the measurement medium or the pH value. The second analyte in the measurement medium can be a second dissolved gas, such as carbon dioxide or ozone.

The above mentioned optochemical sensitive element is advantageous as it allows the determination of multiple parameters with a single sensitive element thus making it economically advantageous when used in a multifunctional optochemical sensor.

The substrate used in the optochemical sensitive element comprises a material selected from the group consisting of glass, polyester, amorphous or partially crystalline polyamide, acrylate, polycarbonate, ethylene-norbornene copolymer (cyclic olefin copolymer). Furthermore, the substrate can also be prepared from a combination of these materials.

In a further embodiment of the optochemical sensitive element, the first sensing layer comprising the first indicator is configured to cover the first surface of a substrate. The second sensing layer comprising the second indicator is configured to cover at least a portion of the second surface of the substrate.

In a further embodiment, the second sensing layer is arranged to cover at least half of the second surface of the substrate. In this arrangement, emitted photoluminescence from the first indicator is collected via a first light path and photoluminescence from the first and second indicator is collected via a second light path. The first and second light path are spatially separated from each other, so that photoluminescence from the first indicator is collected from the half portion of the sensitive element comprising only the first indicator, respectively where the second sensing layer is absent. Likewise, the combined photoluminescence signal from the first and second indicator is collected from the half covered portion of the substrate by the second sensing layer. The signals from the first and second indicator can be separated using their spectral peaks and decay time. The first and/or second light path can further comprise a first and/or second optical fiber for collecting the respective photoluminescence.

In a further embodiment, the second sensing layer is arranged over the second surface of the substrate either in the shape of a disc or in that of an annular ring. In yet a further embodiment, the second sensing layer is disposed over the second surface of the substrate in the shape of a concentric area, which is concentric with the substrate and the first sensing layer.

Optochemical sensitive elements with first and second sensing layers wherein one sensitive layer partially covers the substrate are particularly advantageous because an increased amount of emitted photoluminescence from the first sensing layer can be measured because the influence of the second sensing layer on the photoluminescence can be eliminated or at least reduced. Additionally, the possibility of exciting and/or collecting photoluminescence of only one of the indicators leads to high photoluminescence yields and faster response times.

Another aspect of the invention relates to an optochemical sensor comprising an optochemical sensitive element according to the invention to determine at least two parameters in a measurement medium. The first parameter is a dissolved gas and the second parameter is the temperature of the measurement medium. The optochemical sensor further comprises a sensor housing comprising: at least one light source, at least one detection unit and a light path between the light source and the detection unit; wherein the optochemical sensitive element is configured to be arranged in the light path between the light source and the detection unit.

The optochemical sensitive element comprising the substrate and the two sensing layers is arranged within the optochemical sensor such that the first sensing layer is arranged to be in contact with the measurement medium whereas the second sensing layer is arranged to face away from the measurement medium. This arrangement allows the second sensing layer comprising the temperature sensitive indicator to be closer to a detection unit as compared to the first sensing layer. Furthermore, this arrangement also shields the temperature sensitive indicator from the measurement medium. Additionally, this configuration reduces cross sensitivity of temperature to the analyte in the measurement medium.

The response time of the sensing layer is determined by the diffusion rate of the analyte molecules through the sensing layer which determines how quickly the sensor reacts on the change in the value of a parameter of the analyte in the measurement medium. Thinner sensitive layers are advantageous as they lead to shorter response times.

A method for producing an optochemical sensitive element for determining at least two parameters in a measurement medium comprising the steps of providing a substrate having a first surface and a second surface. Further, the method involves applying a first sensitive layer on the first surface of the substrate using a first application technique wherein the first sensing layer comprises a first indicator immobilized in a first polymer matrix to determine a first parameter in the measurement medium. The method further comprises the step of applying a second sensing layer on the second surface of the substrate using a second application technique wherein the second sensing layer comprises a temperature sensitive indicator immobilized in a second polymer matrix to determine temperature of the measurement medium. The optochemical sensitive element is prepared according to above mentioned steps such that the first sensing layer applied to the first surface of the substrate is configured to be opposite to the second sensing layer applied to the second surface of the substrate.

The application of each sensing layer, namely the first sensing layer and the second sensing layer, as described in the above mentioned method are preferably carried out by different application techniques such as dip-coating, spin-coating, blade coating or screen printing.

This is particularly advantageous when the first and second sensing layer are applied on respective opposite surfaces of the substrate because each sensing layer comprising respective indicators can be applied to each corresponding surface independent of the application technique of the other sensing layer. Therefore, this arrangement allows the sensing layer to be applied to the surface of the substrate by an application technique that is suitable to the sensing layer. Thereby, this method consequently provides an ease in manufacturing of the optochemical sensitive element. This in turn becomes economically advantageous as well. A further advantage of this arrangement is that it eliminates the requirement that the sensing layers comprising respective indicators immobilized on respective polymer matrices need to be mechanically and chemically compatible with each other when applied on the same side of the substrate.

### BRIEF DESCRIPTION OF THE DRAWINGS

Other features and advantages disclosed herein will become more apparent from the following detailed description of exemplary embodiments when read in conjunction with the following figures. The figures show:

FIG. 1 is a schematic of an optochemical sensor;

FIG. 2 is a longitudinal cross sectional view of an optochemical sensitive element housed within an optochemical sensor immersed in a measurement medium;

FIG. 3 is a schematic cross sectional view of an embodiment of an optochemical sensitive element for measuring the temperature and two other parameters in a measurement medium;

FIG. 4 is a schematic cross sectional view of another embodiment of an optochemical sensitive element for measuring the temperature and three other parameters in a measurement medium;

FIG. 5A is a schematic cross sectional view of an embodiment showing an arrangement of a second sensing layer of an optochemical sensitive element;

FIG. 5B is a schematic top view of embodiment shown in FIG. 5a showing the arrangement of the second sensing layer of the optochemical sensitive element;

FIG. 6A is a schematic cross sectional view of an embodiment showing an arrangement of a second sensing layer of an optochemical sensitive element;

FIB 6B is a schematic top view of embodiment shown in FIG. 6a showing the arrangement of the second sensing layer of the optochemical sensitive element;

FIG. 7A is a schematic cross sectional view of an embodiment showing an arrangement of a second sensing layer of an optochemical sensitive element;

FIG. 7B is a schematic top view of embodiment shown in FIG. 7a showing the arrangement of the second sensing layer of the optochemical sensitive element; and

FIG. 8 is a schematic cross sectional view of an embodiment of an optochemical sensitive element comprising various layers.

### DETAILED DESCRIPTION OF THE EMBODIMENTS

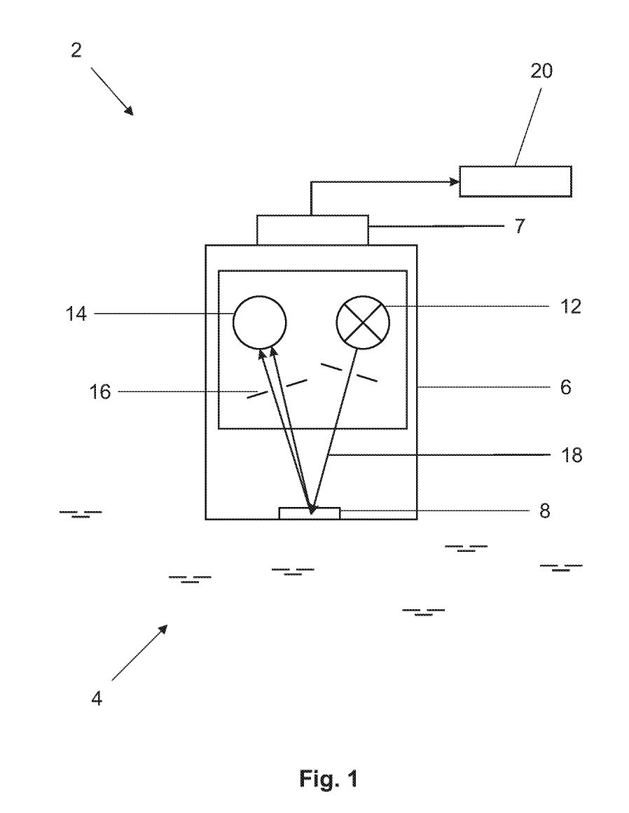

FIG. 1 shows a schematic cross sectional view of an optochemical sensor 2 immersed in a measurement medium 4. The optochemical sensor 2 has two ends, a distal end that is immersed in the measurement medium 4 and a proximal end having a sensor head 7, which is connected via a wire or wireless connection to a control unit 20. An optochemical sensitive element 8 is arranged at the distal end of the optochemical sensor 2 that is immersed in the measurement medium 4.

Further, the optochemical sensor 2 comprises a light source 12, a detection unit 14 and optical elements 16 housed within a sensor housing 6. Further, the optochemical sensor can comprise more than one light source and/or more than one detector respectively within the sensor housing 6.

During measurement operation of the optochemical sensor 2 based on the principle of photoluminescence, excitation light is emitted by the light source 12 and is directed by optical elements 16, such as filters, mirrors or lenses, towards the optochemical sensitive element 8 such that the emitted light interacts with the optochemical sensitive element 8. A light path is indicated by arrows 18. The optochemical sensitive element 8 is arranged in the light path 18 between the light source 12 and detection unit 14, as seen in FIG. 1. A photoluminescence response signal, in particular a fluorescence or phosphorescence response signal that is emitted after excitation interacts with the optochemical sensitive element 8 and is detected by the detection unit 14. As previously described, in optochemical sensors based on photoluminescence a reduction in the photoluminescence caused by an analyte in the measurement medium is detected. The detection unit 14 comprises at least one detector, for example a photodiode. Depending on the number of parameters in the measurement medium to be measured, the detection unit 14 can further comprise corresponding detectors for one or more of the parameters. The detection unit 14 further comprises optical filters that are positioned in front of the detectors. These optical filters help in separating signals that are received from the optochemical sensitive element 8. The sensor further comprises optical fibers to direct the light to and/or emit the light from the optochemical sensitive element 8.

The response signal received by the detection unit 14 is amplified and processed by the control unit 20. The control unit 20 is connected via a wired or wireless connection to the sensor head 7 and it can also function as a regulation unit. The control unit 20 can further be connected to a terminal which in turn can be connected to a display, a process control system, a transmitter or a further processing unit and/or similar devices. The control unit 20 is arranged either as an external unit or also entirely or in part inside the sensor housing 6. In this embodiment, the control unit 20 has a wire-bound or wireless connection to the sensor head 7 of the optochemical sensor 2. The state of the art includes different variants of the control unit 20 and the latter is therefore only symbolically illustrated. The optochemical sensitive element 8 is releasably connected to the sensor housing 6 so that the optochemical sensitive element 8 can be easily replaced.

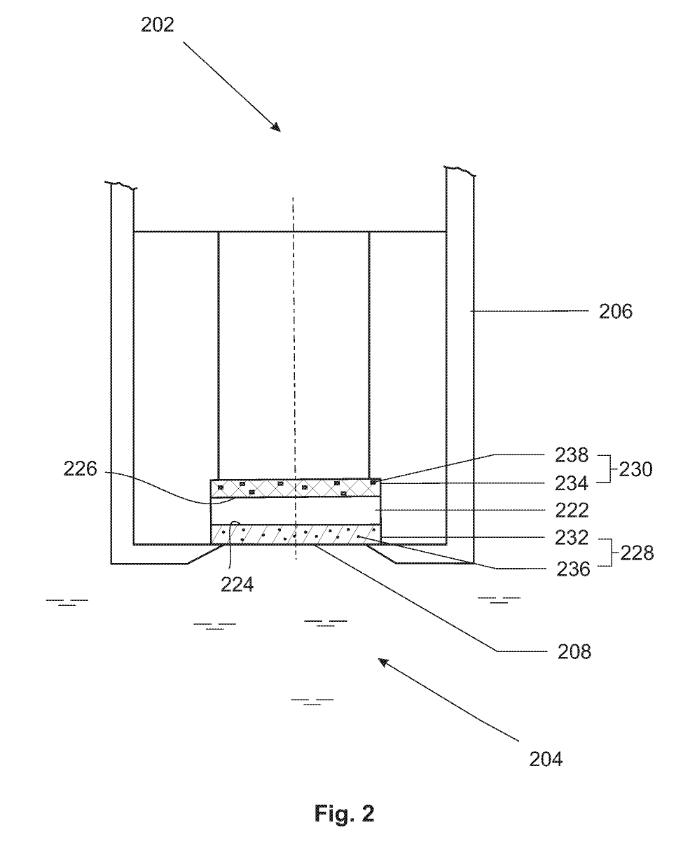

FIG. 2 shows a longitudinal cross sectional view of an optochemical sensitive element 208 housed within an optochemical sensor 202. The optochemical sensitive element 208 is shown to be arranged at a distal end of an optochemical sensor 202 that is immersed in a measurement medium 204. The optochemical sensitive element 208 comprises at least two sensing layers i.e. a first sensing layer 228 and a second sensing layer 230 arranged on a substrate 222. The first sensing layer 228 is arranged on a first surface 224 of the substrate 222. The second sensing layer 230 is arranged on a second surface 226 of the substrate 222. The substrate 222 is arranged within a sensor housing 206 such that first surface 224 of the substrate 222 is arranged to face towards the measurement medium 204 while the second surface 226 of the substrate 222 is arranged to face away from the measurement medium 204.

Example shapes or geometries of substrates include but are not limited to rectangular, hexagonal, circular, triangular, square-formed or polygonal substrates. The substrate 222 is optically transparent to an excitation light emitted from a light source (see FIG. 1). Preferably, the substrate 222 is made of glass. It can also be made from any of the following materials: polyester, amorphous or partially crystalline polyamide, acrylate, polycarbonate, ethylene-norbornene copolymer (cyclic olefin copolymer) or combinations of these materials thereby being a hybrid substrate.

The first sensing layer 228 arranged on the first surface 224 of the substrate 222 determines a first parameter in the measurement medium 204. The second sensing layer 230 arranged on the second surface 226 of the substrate 222 determines the temperature of the measurement medium 204.

In a preferred embodiment, the first sensing layer 228 is configured to determine the first parameter, such as the concentration of a dissolved gas, in the measurement medium 204. The first sensing layer 228 comprises a first indicator 236 immobilized in a first polymer matrix 232. The second sensing layer 230 comprises a temperature sensitive indicator 238 immobilized in a second polymer matrix 234.

Examples of polymers that can be used to form optically transparent polymer matrices of the respective sensing layers are: polystyrene film, cyclic olefin copolymers such as ethylene-norbornene copolymer, cyclic olefin polymer (“COP”) and poly(n-methyl methacrylimide) (PMMI) or mixtures thereof. Alternatively, the second sensing layer can employ silicone polymers for its polymer matrix composition. Moreover to better suit each indicator, the first polymer matrix 232 and second polymer matrix 234 can be made from different polymers. Further, it is also possible that the indicators are immobilized in the same polymer matrix material.

Polymer matrices provide a considerable amount of good mechanical stability and thus immobilizing indicators in them becomes advantageous. Additionally, these matrices are also known to withstand the acidic and/or basic cleaning processes, which are, for example used in chemical process environments, and this in turn provides an optochemical sensitive element with a longer service life.

A suitable indicator to detect an analyte of interest in a measurement medium is selected based on the basis of the type of analyte to be determined, its solubility in a polymer matrix as well as its photoluminescence lifetimes and the dependency of the photoluminescence quenching from the parameter being measured.

In an exemplary embodiment where the optochemical sensitive element 208 is used to determine the temperature-compensated oxygen concentration in the measurement medium 204, a suitable indicator is chosen for the measurement of oxygen concentration in the measurement medium. Subsequently, the second sensing layer 230 takes into account temperature changes in the measurement medium 204 during said measurement of the said first parameter by compensating for temperature changes thereby providing the temperature compensated measurement of the oxygen concentration in the measurement medium 204.

Examples of suitable indicators for the measurement of oxygen are metal-organic complexes comprising polycyclic aromatic hydrocarbons such as pyrene and/or pyrene derivatives, oxygen sensitive transitional metal polypyridil complex, in particular [Ru(bpy)₃]²⁺ or metalloporphyrin complex comprising in particular platinum or palladium. Additionally, there are numerous commercially available indicators that may be used in the measurement of oxygen.

In a further exemplary embodiment, the optochemical sensitive element 208 is configured for determining the first parameter, in particular the concentration of a dissolved gas, such as carbon dioxide or ozone, in the measurement medium 204. The measurement of this parameter is temperature compensated by correspondingly measuring the temperature of the measurement medium 204 utilizing the temperature sensitive indicator 238 of the second sensing layer 230. A suitable indicator for the measurement of dissolved carbon dioxide is 8-hydroxypyrene-1,3,6-trisulfonic acid.

Providing a temperature sensitive indicator 238 in the second sensing layer 230 facing away from the measurement medium 204 offers an advantage that it allows the temperature sensitive indicator to be protected from the measurement medium, specifically as protection from corrosive measurement media.

Preferably, the temperature sensitive indicator is chosen from any of rhodamine complex or its derivatives, metal ligand complex, in particular [Ru(bpy)₃]²⁺ or lanthanide-doped bulk material, in particular doped Al₂O₃ or YAB doped with chromium ions.

Known temperature sensitive indicators are less efficient photoluminescent emitters compared to indicators sensitive for dissolved gases, such as oxygen, carbon dioxide or ozone. Therefore, this is compensated by separating the temperature sensing layer 230 comprising the temperature sensitive indicator 238 from the at least first sensing layer 228 comprising the at least first indicator 236 and thus bringing it closer to the optical detection unit (see FIG. 1) in the sensor housing 206 of the optochemical sensor 202. This arrangement also allows the temperature sensing layer 230 to be disposed as a thin layer on the substrate 222 thereby leading to a faster response time of the optochemical sensitive element 208.

The excitation range for exciting the first sensing layer 228 comprising the first indicator 236, preferably adapted of an optochemical sensor for measuring dissolved oxygen, lies preferably in the range of 390 to 570 nm. The excitation range for exciting the second sensing layer 230 comprising the temperature sensitive indicator 238 lies preferably in the range of 390 to 670 nm. The excitation ranges are chosen based on spectral range or the photoluminescence answer from the respective indicator and/or sensing layer.

The light detection range for the first indicator 236, in particular the oxygen sensitive indicator, lies in the range of 600 to 870 nm whereas that for the temperature sensitive indicator 238 lies in the range of 630 to 800 nm.

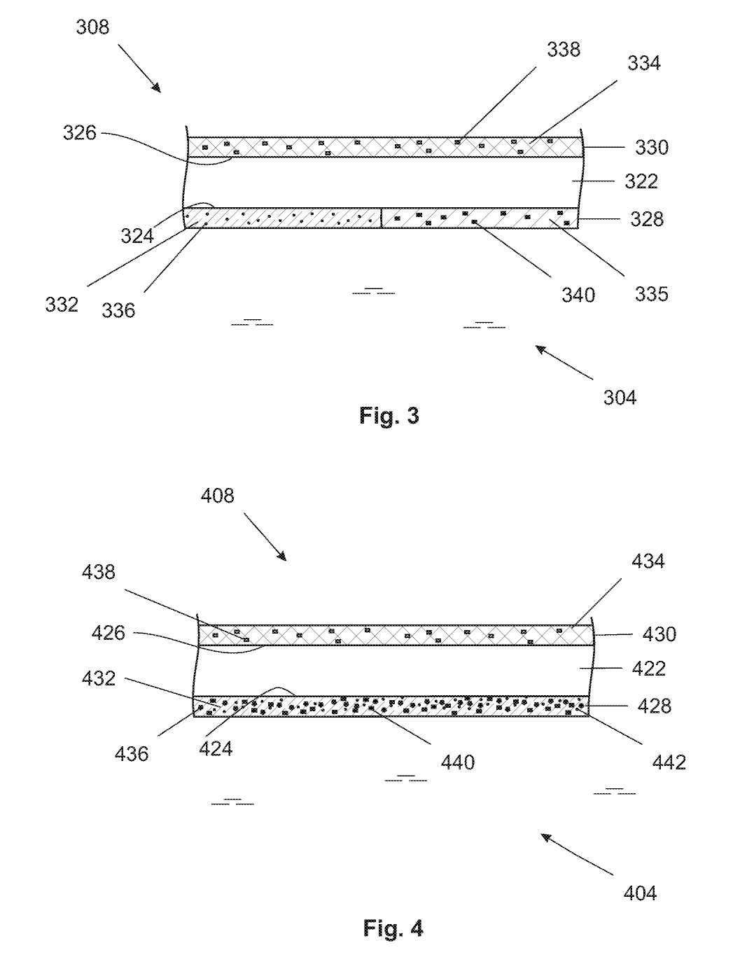

FIG. 3 shows a schematic cross sectional view of an embodiment of an optochemical sensitive element 308 for measuring the temperature and two parameters in a measurement medium. A first sensing layer 328 and a second sensing layer 330 are applied to a first surface 324 and second surface 326 of a substrate 322 respectively. The first sensing layer 328 comprises a first indicator 336 immobilized in a first polymer matrix 332 and a second indicator 340 immobilized in a third polymer matrix 335. In a further embodiment, the first indicator 336 and the second indicator 340 are immobilized in the same polymer matrix.

The second sensing layer 330 comprises a temperature sensitive indicator 338 immobilized in a second polymer matrix 334. The composition of the first, second and/or third polymer matrix (332, 334, 335) can be the same or can differ. Examples of materials suitable as polymer matrices for either of the first, second or third polymer matrices are as follows: polystyrene film, cyclic olefin copolymer (“COC”) such as ethylene-norbornene copolymer, cyclic olefin polymer (“COP”) or poly(n-methyl methacrylimide) (PMMI) or a combination thereof. Alternatively, the second sensing layer 330 can employ silicone polymers for its polymer matrix composition.

The first indicator 336 present in the first sensing layer 328 is sensitive to a first parameter in a measurement medium 304 and the second indicator 340 present in the third sensing layer 335 is sensitive to a second parameter in the measurement medium 304. The temperature sensitive indicator 338 allows the measurement of the temperature in the measurement medium 304 thus allowing for temperature compensated measurements of the first and/or second parameters of interest present in the measurement medium 304.

In a further embodiment of an optochemical sensitive element 408, a first sensing layer 428 comprising three indicators for measuring three parameters is shown in FIG. 4. A first indicator 436, a second indicator 440 and a third indicator 442 are immobilized in a first polymer matrix 432. This first sensing layer 428 is applied on a first surface 424 of a substrate 422 and a second sensing layer 430 comprising a temperature sensitive indicator 438 immobilized in a second polymer matrix 434 is applied on a second surface 426 of the substrate 422.

In principle, it is possible to determine the concentration of different parameters in a measurement medium by photoluminescence quenching so long as the indicator is sensitive in regards to the parameter of interest.

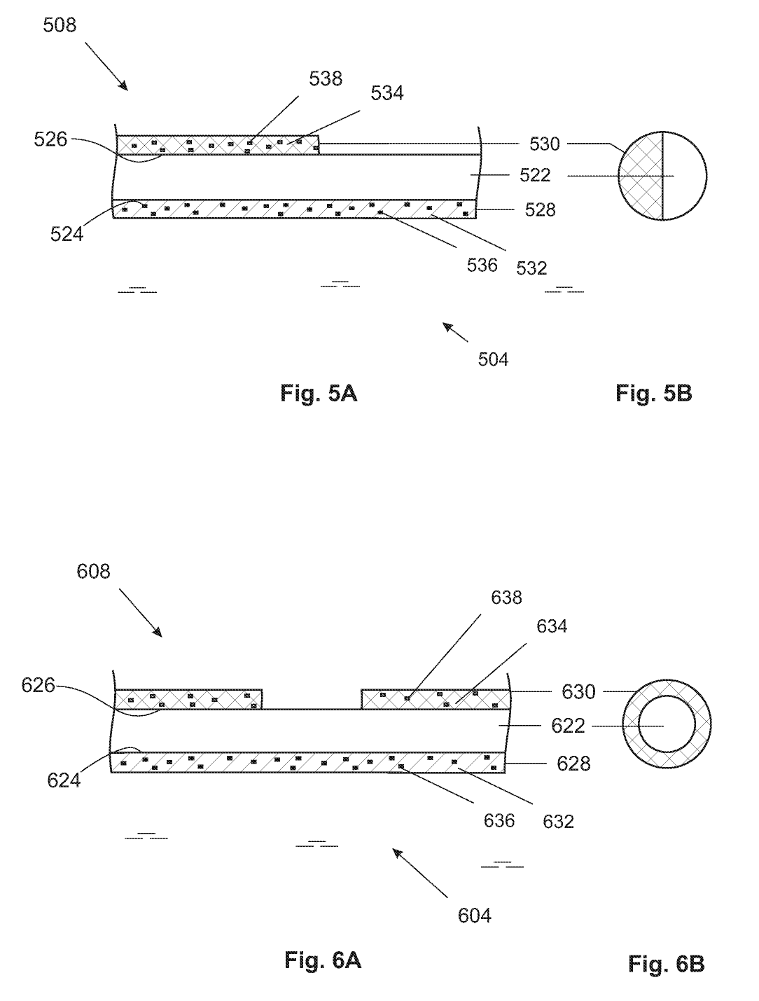

FIGS. 5A and 5B show a cross sectional side view and top view respectively of an embodiment showing an arrangement of a second sensing layer 530 of an optochemical sensitive element 508. The first sensing layer 528 is arranged on a first surface 524 of a substrate 522. Preferably, the first sensing layer 528 covers the entire surface area of the first surface 524 of the substrate 522. The second sensing layer 530 is arranged on a portion of a second surface 526 of the substrate 522.

FIG. 5B provides a top view of the section of the optochemical sensitive element as shown in FIG. 5A. Preferably, the second sensing layer is arranged on half of the area of the second surface 526 of the substrate 522, as clearly depicted in FIG. 5B.

FIGS. 6A and 6B show a cross sectional side view and top view respectively of an embodiment showing an arrangement of a second sensing layer 630 of an optochemical sensitive element 608. The second sensing layer 630 of the optochemical sensitive element 608 is arranged as a particular shape to cover a portion of a second surface 626 of a substrate 622. Preferably, the second sensing layer 630 is arranged in the shape of an annular ring 630 on the surface 626 of the substrate 622 as can be clearly seen in FIG. 6B. The outer radius of the second sensing layer 630 is approximately equal to the outer radius of the substrate 622 such that the annular ring shaped second sensing layer 630 is arranged concentrically with the substrate 622.

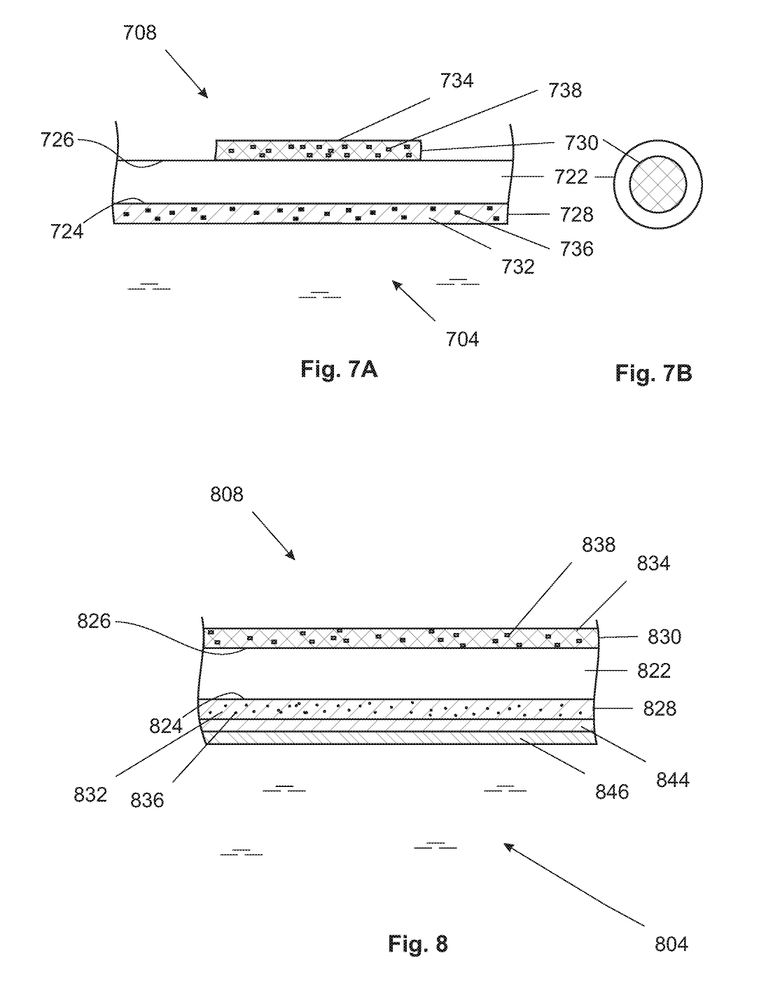

FIGS. 7A and 7B show a cross sectional side view and top view respectively of an embodiment showing an arrangement of a second sensing layer 730 of an optochemical sensitive element 708. In this embodiment, the second sensing layer 730 is arranged as having a particular shape to cover a portion of a second surface 726 of a substrate 722. Preferably, the second sensing layer 730 is arranged in the shape of a disc 730. Therefore, in this case the outer radius of the second sensing layer 730 is lesser than the outer radius of the substrate 722, such that the disc shaped second sensing layer 730 is arranged concentrically with the substrate 722 as seen in FIG. 7B.

In a further embodiment, the shape of the second sensing layer 730 is from any of the following but not limited to these shapes or geometries: rectangular, hexagonal, circular, triangular, square-formed or polygonal.

The embodiments shown in FIGS. 5 to 7 are advantageous because an increased amount of emitted photoluminescence can be received by a detector from the first sensing layer since only a portion of a substrate of an optochemical sensitive element is covered by the temperature sensitive second sensing layer thereby resulting in higher luminescence yields and faster response times, in particular for a first indicator present in the first sensitive layer facing the measurement medium.

In a further embodiment, shown in FIG. 8, an optochemical sensitive 808 element comprises at least one cover layer that is applied over a first sensing layer 828. This embodiment of the optochemical sensitive element 808 comprises at least a first cover layer 844. The first cover layer 844 is arranged on the first sensing layer 828 and it serves as a light reflection layer. Such an arrangement is advantageous because the first cover layer 844 essentially reflects almost all excitation radiation back into the sensitive layer. This arrangement particularly helps in achieving a higher luminescence yield and provides a measuring device with shorter response times. An example of a suitable material as a light reflection layer is white silicone, preferably doped with metallic particles.

As shown in FIG. 8, the optochemical sensitive element 808 can further be covered with a second cover layer 846 that is arranged on the first cover layer 844. In this case, the second cover layer 846 serves as a stray light protection layer and is for example a black silicone layer comprising carbon. The advantageous feature of including the stray light protection layer as the second layer is that it blocks stray light that could possibly enter from the medium and interfere with the measurement results.

The first 844 and second 846 cover layers are preferably permeable to the parameter to be measured.

An optochemical sensor preferably comprises a sensitive element according to the invention, which can be releasably housed or attached to the sensor housing. This essentially allows the optochemical sensitive element to be replaced or exchanged when a parameter sensitive indicator within the optochemical sensitive element is used up or has aged.

A method to produce an optochemical sensitive element to determine at least two parameters in a measurement medium comprising the following steps: providing a substrate having at least a first surface and at least a second surface. Further, the method involves applying a first sensitive layer on the first surface of the substrate using a first application technique wherein the first sensing layer comprises a first indicator immobilized in a first polymer matrix to determine a first parameter in the measurement medium. The method further comprises the step of applying a second sensing layer on the second surface of the substrate using a second application technique wherein the second sensing layer comprises a temperature sensitive indicator immobilized in a second polymer matrix to determine temperature of the measurement medium. The optochemical sensitive element is prepared according to the above mentioned steps such that the first sensing layer applied to the first surface of the substrate is configured to be opposite to the second sensing layer applied to the second surface of the substrate.

The first sensing layer and the second sensing layer can be applied by any one of the following application techniques of spin coating, dip coating, blade coating or screen printing. In an embodiment, the application techniques of the first and the second sensing layers are different from each other. This is particularly advantageous when different application methods are better suited to the polymer matrix comprising the suitable indicator.

In another embodiment, the first sensing layer sensitive to dissolved oxygen is applied by spin coating to the first surface of the substrate. In a further preferred embodiment, the second sensing layer comprising the temperature sensitive indicator is applied by means of blade coating to the second surface of the substrate.

In a further embodiment, the first sensing layer comprises two or more indicators that are immobilized on different polymer matrices. Each sensitive region or spot can be applied individually by any one of the application techniques over the substrate, preferably by an application technique that is well suited for forming film comprising the polymer matrix and the corresponding immobilized indicator.

The method further includes a step wherein the optochemical sensitive element is arranged in an optochemical sensor such that the first sensing layer faces the measurement medium whereas the second sensing layer faces away from the measurement medium.

What is claimed is:

1. An optochemical sensitive element for determining at least two parameters in a measurement medium, the element comprising:
a substrate comprising a first surface and a second surface, the first and second surfaces being on opposite sides of the substrate;
at least one first sensing layer arranged on the first surface of the substrate, each of the first sensing layers comprising a first indicator for determining a first parameter, immobilized in a first polymer matrix; and
at least one second sensing layer arranged on the second surface of the substrate, each of the second sensing layers comprising a temperature sensitive indicator for determining a temperature of the measurement medium, immobilized in a second polymer matrix.

2. The optochemical sensitive element of claim 1, wherein the first parameter is a concentration of a dissolved gas in the measurement medium.

3. The optochemical sensitive element of claim 2, wherein the first indicator is adapted for determining oxygen concentration and comprises a substance selected from the group consisting of: metal-organic complex comprising polycyclic aromatic hydrocarbon, such as pyrene and/or its derivatives, oxygen sensitive transitional metal polypyridil complex in particular [Ru(bpy)₃]²⁺ or metalloporphyrin complex comprising in particular platinum or palladium, derivatives thereof and combinations thereof.

4. The optochemical sensitive element of claim 2, wherein the first indicator is adapted for determining carbon dioxide concentration and comprises 8-hydroxypyrene-1,3,6-trisulfonic acid.

5. The optochemical sensitive element of claim 1, wherein the temperature sensitive indicator comprises a substance selected from the group consisting of: rhodamine complex, temperature sensitive metal ligand complex in particular [Ru(bpy)₃]²⁺ or lanthanide-doped bulk materials, in particular doped Al₂O₃ or YAB doped with chromium ions, derivatives thereof and combinations thereof.

6. The optochemical sensitive element of claim 1, wherein at least one of the first and second polymer matrices comprises a substance selected from the group consisting of: polystyrene film, cyclic olefin copolymer, poly (n-methyl methacrylimide) and combinations thereof.

7. The optochemical sensitive element of claim 1, wherein the respective first and second polymer matrices are different in composition.

8. The optochemical sensitive element of claim 1, wherein the first sensing layer comprises a second indicator for determining the pH of the measurement medium.

9. The optochemical sensitive element of claim 1, wherein the substrate comprises a material selected from the group consisting of glass, polyester, amorphous polyamide, partially crystalline polyamide, acrylate, polycarbonate, ethylene-norbornene copolymer (cyclic olefin copolymer) and combinations thereof.

10. The optochemical sensitive element of claim 1, wherein the first sensing layer covers the first surface of the substrate.

11. The optochemical sensitive element of claim 1, wherein the second sensing layer covers at least a portion of the second surface of the substrate.

12. The optochemical sensitive element of claim 11, wherein the second sensing layer is arranged on the second surface of the substrate as any of the following shapes: a disc or an annular ring.

13. An optochemical sensor comprising:
an optochemical sensitive element, according to claim 1, for determining, in a measurement medium, at least two parameters thereof; and
a sensor housing comprising:
at least one light source, and
at least one detection unit,
wherein the optochemical sensitive element is arranged in a light path between the light source and detection unit.

14. A method for producing an optochemical sensitive element for determining at least two parameters in a measurement medium, the method comprising the steps of:
providing a substrate having a first surface and a second surface;
applying a first sensing layer on the first surface using a first application technique, wherein the first sensing layer comprises a first indicator for determining a first parameter in the measurement medium, immobilized in a first polymer matrix;
applying a second sensing layer on the second surface using a second application technique, wherein the second sensing layer comprises a temperature sensitive indicator for determining a temperature of the measurement medium, immobilized in a second polymer matrix;
wherein the first sensing layer applied to the first surface of the substrate is configured to be opposite to the second sensing layer applied to the second surface of the substrate.

15. The method of claim 14, wherein at least one of the first and second application techniques is chosen from the group consisting of: spin coating, blade coating, dip coating and screen printing.

16. The optochemical sensitive element of claim 2, wherein the first parameter is the concentration of ozone in the measurement medium.

17. The optochemical sensitive element of claim 2, wherein the first sensing layer comprises a second indicator for determining the concentration of a second dissolved gas, different from the first dissolved gas.
